(19) United States
(12) Patent Application Publication
(10) Pub. No.: US 2026/0080762 A1
(43) Pub. Date: Mar. 19, 2026

(54) EFFECTIVE SECURITY RESOURCE MANAGMENT USING DATA ANALYTICS

(71) Applicant: Honeywell International Inc., Charlotte, NC (US)

(72) Inventors: Abhisekh Jain, Madurai (IN); Bhupesh Koli, Bangalore (IN)

(21) Appl. No.: 18/889,902

(22) Filed: Sep. 19, 2024

(51) Int. Cl. G08B 13/196; G08B 25/00

(52) U.S. Cl. CPC G08B 13/19602; G08B 25/008

(57) ABSTRACT

Alarms issued by a security system may be received, with each alarm including an alarm type, an alarm time stamp, and an alarm location in the facility. The received alarms are logged in an alarm log. Alarms in the alarm log that have an alarm time stamp that fall within a predetermined time window of interest are identified. Based at least in part on the identified alarms, a prediction is made that a first one of the plurality of secure regions of the facility will have at least a first threshold number of alarms during a first predicted future time period. A first indication is outputted that the first one of the plurality of secure regions of the facility is predicted to have at least the first threshold number of alarms during the first predicted future time period.

### TECHNICAL FIELD

The present disclosure relates generally to security systems, and more particularly to methods of operating a security system.

### BACKGROUND

Security systems may be responsible for maintaining security within a large facility. A large facility may deploy a large number of security personnel, including security guards and security system operators. It can be difficult to determine how to best direct the attention of the security personnel, particularly as it can be difficult to predict where within the facility problems may occur. Regions of the facility in which problems are expected to occur may require additional attention while regions of the facility in which problems are not expected to occur may require less attention. Expected problems may be time-related. For example, problems may be expected in a first region of the facility at a first time of day, and problems may be expected in a second region of the facility at a different time of time. Unfortunately, it can be difficult to predict these times of day, and the particular regions in which problems are expected. What would be desirable are systems and methods for improving security resource management by better identifying when and where security personnel attention should be directed. What would be desirable are systems and methods in which potential hot spots are identified based on data representing previous detected events.

### SUMMARY

The present disclosure relates generally to security systems, and more particularly to methods of operating a security system. An example may be found in a method for operating a security system of a facility that includes a plurality of secure regions. The illustrative method includes receiving alarms issued by the security system of the facility, wherein each alarm includes an alarm type, an alarm time stamp, and an alarm location in the facility. The received alarms are logged in an alarm log. Alarms in the alarm log that have an alarm time stamp that fall within a predetermined time window of interest are identified (e.g. past 7 days). Based at least in part on the identified alarms, a prediction is made that a first one of the plurality of secure regions of the facility will have at least a first threshold number of alarms during a first predicted future time period. A first indication is outputted that the first one of the plurality of secure regions of the facility is predicted to have at least the first threshold number of alarms during the first predicted future time period. In some cases, an output may be provided that directs attention of at least one security personnel to the first one of the plurality of secure regions of the facility during the first predicted future time period.

Another example may be found in a security system for a facility. The illustrative security system includes a plurality of secure regions, one or more alarm generating devices, and a controller that is operatively coupled to the one or more alarm generating devices. The controller is configured to receive alarms issued by the alarm generating devices of the security system, wherein each alarm includes an alarm type, an alarm time stamp, and an alarm location in the facility. The controller is configured to log the received alarms in an alarm log and to identify alarms in the alarm log that have an alarm time stamp that fall within a predetermined time window of interest (e.g. past 7 days). Based at least in part on the identified alarms, the controller is configured to predict that a first one of the plurality of secure regions of the facility will have at least a first threshold number of alarms during a first predicted future time period. The controller is configured to output a first indication that the first one of the plurality of secure regions of the facility is predicted to have at least the first threshold number of alarms during the first predicted future time period. In some cases, the controller is configured to output that directs attention of at least one security personnel to the first one of the plurality of secure regions of the facility during the first predicted future time period.

Another example may be found in a non-transitory computer readable medium storing instructions thereon. When the instructions are executed by one or more processors, the one or more processors are caused to receive alarms issued by a security system of a facility, wherein each alarm includes an alarm time stamp. The one or more processors are caused to store the received alarms in an alarm log and to identify alarms in the alarm log that have an alarm time stamp that fall within a predetermined time window of interest (e.g. past 7 days). Based at least in part on the identified alarms, the one or more processors are caused to predict that a first one of a plurality of secure regions of the facility will have at least a first threshold number of alarms during a first predicted future time period. The one or more processors are caused to provide an output that directs attention of at least one security personnel to the first one of the plurality of secure regions of the facility during the first predicted future time period.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative security system;

FIGS. 2A and 2B are flow diagrams that together show an illustrative method for operating the illustrative security system of FIG. 1;

FIG. 3 is a flow diagram showing an illustrative method;

FIG. 4 is a flow diagram showing an illustrative method;

FIG. 5 is a flow diagram showing an illustrative method;

FIG. 6 is a flow diagram showing an illustrative method;

FIG. 7 is a flow diagram showing an illustrative method;

FIG. 8 is a flow diagram showing an illustrative method;

FIG. 9 is a flow diagram showing an illustrative method;

FIG. 10 is a flow diagram showing an illustrative method;

FIG. 11 is a flow diagram showing an illustrative method.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

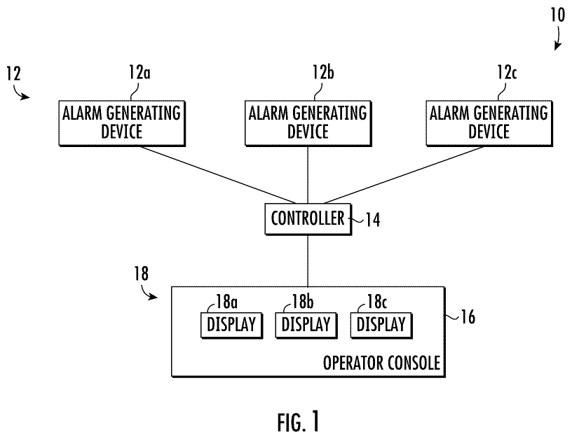

FIG. 1 is a schematic block diagram showing an illustrative security system 10. The illustrative security system 10 may be deployed within a facility such as a building, for example. The facility may include a number of secure areas. The illustrative security system 10 includes a number of alarm generating devices 12, individually labeled as 12a, 12b and 12c. While a total of three alarm generating devices 12 are shown, in some cases the security system 10 may include substantially more than three alarm generating devices 12. The security system 10 may include hundreds or even thousands of alarm generating devices 12. The alarm generating devices 12 may include security sensors such as door open sensors, window open sensors, motion sensors such as PIR (passive infrared) sensors, glass break detectors, smoke detectors, fire detectors, and others. The alarm generating devices 12 may include video cameras and accompanying video analytics algorithms. These are just examples. The alarm generating devices 12 are operatively coupled with a controller 14. The controller 14 is also coupled with an operator console 16 including a number of displays 18, individually labeled as 18a, 18b and 18c. The operator console 16 may include any number of displays 18, and may include more than three displays 18.

The controller 14 may be configured to receive alarms issued by the alarm generating devices 12 of the security system 10. In some cases, each alarm includes an alarm type, an alarm time stamp, and an alarm location in the facility. In some cases, each alarm may include one or more of a device type of a device that generated the respective alarm, a device ID of the device that generated the respective alarm, an indication of how the respective alarm was resolved by a security operator, and an indication of how and which security operator resolved the respective alarm.

The controller 14 may be configured to log the received alarms in an alarm log and to identify alarms in the alarm log that have an alarm time stamp that fall within a predetermined time window of interest. As an example, the predetermined time window of interest may be the past seven (7) days, although other time periods are contemplated. Based at least in part on the identified alarms, the controller 14 may be configured to predict that a first one of the plurality of secure regions of the facility will have at least a first threshold number of alarms during a first predicted future time period. The first threshold number of alarms may be 1, or any integer greater than one. In some cases, the alarms in the alarm log may be filtered by alarm type and/or alarm severity to identify the alarms of interest. For example, the alarms of interest may be selected to only have a selected alarm type or combination of alarm types in the facility, and/or have at least a selected alarm severity. The controller 14 may be configured to output a first indication that the first one of the plurality of secure regions of the facility is predicted to have at least the first threshold number of alarms (e.g. alarms of interest) during the first predicted future time period (e.g. Tuesday at 10:15 AM-10:22 AM). In some cases, the controller 14 may be configured to, when outputting the first indication, display a first salvo on the operator console 16 of the security system 10 at the first predicted future time period, wherein the first salvo includes a first camera feed that corresponds to the first one of the plurality of secure regions.

In some cases, the controller 14 may be configured to, based at least in part on the identified alarms, predict a second one of the plurality of secure regions of the facility will have at least a second threshold number of alarms (e.g. alarms of interest) during a second predicted future time period. The controller 14 may be configured to output a second indication that the second one of the plurality of secure regions of the facility is predicted to have at least the second threshold number of alarms during the second predicted future time period. Outputting the second indication may include displaying a second salvo on the operator console 16 of the security system 10 at the second predicted future time period, wherein the second salvo includes a second camera feed that corresponds to the second one of the plurality of secure regions. In some cases, the displays 18 include a dedicated hotspot display, and the controller 14 may be configured to display the first salvo on the dedicated hotspot display, and to display the second salvo on the dedicated hotspot display. In some cases, the first camera feed may be initiated in the first salvo just prior to the first predicted future time period and may remain on the first salvo sometime after the first predicted future time period. Likewise, the second camera feed may be initiated in the second salvo just prior to the second predicted future time period and may remain on the second salvo sometime after the second predicted future time period.

In some cases, the controller 14 may be configured to build a security guard tour plan for one or more security guards of the facility, wherein the security guard tour plan places one or more security guards at the first one of the plurality of secure regions during the first predicted future time period. In some cases, the controller 14 may be configured to determine one or more upgrades and/or one or more configuration setting changes for the security system 10. The controller 14 may be configured to implement one or more of the upgrades and/or one or more of the configuration setting changes to the security system. In some cases, the security system 10 may include a plurality of security cameras each providing a respective camera feed, and wherein one or more of the upgrades may include adding one or more video analytics algorithms to process one or more camera feeds of the plurality of security cameras and/or adding one or more security cameras to the security system. As an example, adding one or more video analytics algorithms may include adding a video analytics algorithm that provides video summarization of one or more camera feeds of the plurality of security cameras to the operator console 16 of the security system 10. As another example, adding one or more video analytics algorithms may include adding a facial recognition video analytics algorithm to one or more camera feeds of the plurality of security cameras.

In some cases, the controller 14 may be configured to log in an alarm log an indication of how the respective alarm was resolved by a security operator and/or which of the security operators resolved the respective alarm. The controller 14 may be configured to determine one or more of the configuration setting changes such as tightening one or more security settings and/or relaxing one or more security settings based at least in part on the indication of how one or more of the alarms were resolved. In some cases, the controller 14 may be configured to determine one or more of the configuration setting changes that direct certain alarm types to certain identified security operator based on the which of the security operators successfully and efficiently resolved the various alarms.

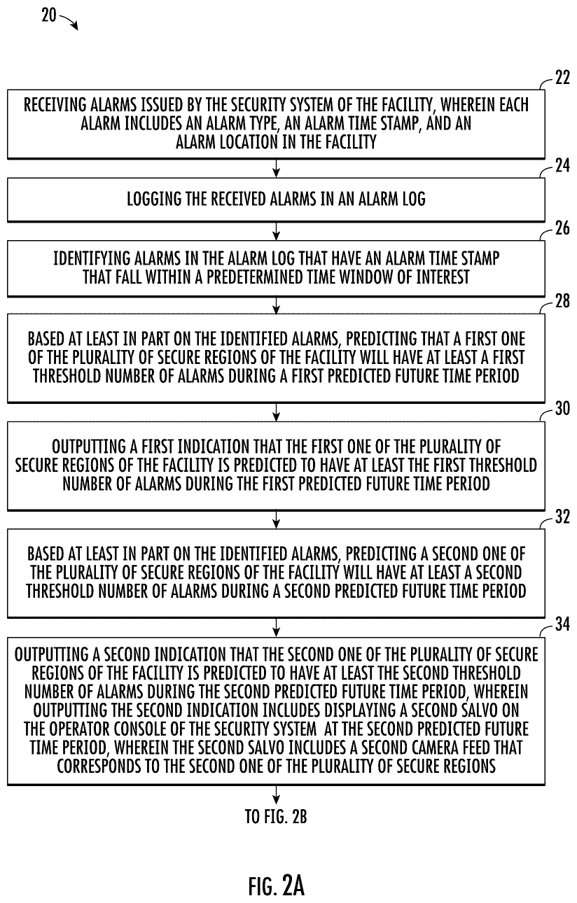

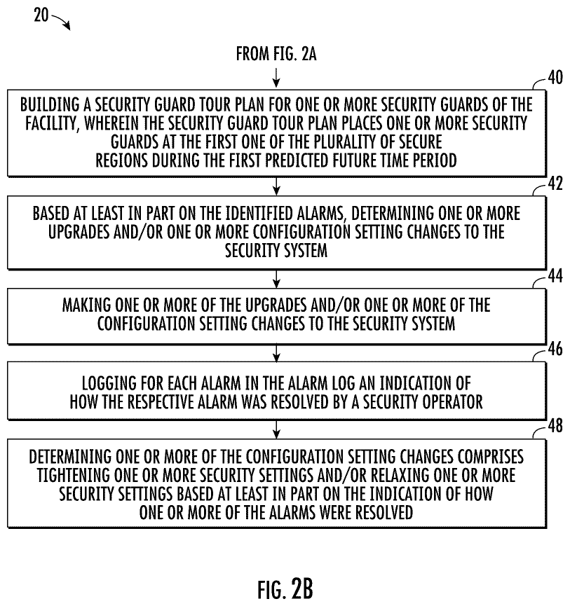

FIGS. 2A and 2B are flow diagrams that together show an illustrative method 20 for operating a security system (such as the security system 10) of a facility that includes a plurality of secure regions. The method 20 includes receiving alarms issued by the security system of the facility, wherein each alarm includes an alarm type, an alarm time stamp, and an alarm location in the facility, as indicated at block 22. The received alarms are logged in an alarm log, as indicated at block 24. Alarms are identified in the alarm log that have an alarm time stamp that fall within a predetermined time window of interest, as indicated at block 26. The predetermined time window of interest may be the past seven (7) days, for example, although other time periods are contemplated. Based at least in part on the identified alarms, a prediction may be made that a first one of the plurality of secure regions of the facility will have at least a first threshold number of alarms (sometimes of a certain alarm type) during a first predicted future time period, as indicated at block 28. A first indication may be outputted that the first one of the plurality of secure regions of the facility is predicted to have at least the first threshold number of alarms during the first predicted future time period, as indicated at block 30.

In some cases, outputting the first indication may include displaying a first salvo on an operator console of the security system at the first predicted future time period, wherein the first salvo includes a first camera feed that corresponds to the first one of the plurality of secure regions. In some cases, the method 20 may further include, predicting a second one of the plurality of secure regions of the facility will have at least a second threshold number of alarms during a second predicted future time period, as indicated at block 32. A second indication may be outputted that the second one of the plurality of secure regions of the facility is predicted to have at least the second threshold number of alarms during the second predicted future time period. Outputting the second indication may include displaying a second salvo on the operator console of the security system at the second predicted future time period, wherein the second salvo includes a second camera feed that corresponds to the second one of the plurality of secure regions, as indicated at block 34. In some cases, the operator console may have a plurality of displays including a dedicated hotspot display, and outputting the first indication may include displaying the first salvo on the dedicated hotspot display, and outputting the second indication may include displaying the second salvo on the dedicated hotspot display.

In some cases, the method 20 may include building a security guard tour plan for one or more security guards of the facility, where the security guard tour plan places one or more security guards at the first one of the plurality of secure regions during the first predicted future time period, as indicated at block 40. In some cases, the method 20 may include, based at least in part on the identified alarms, determining one or more upgrades and/or one or more configuration setting changes to the security system, as indicated at block 42. The method 20 may include making one or more of the upgrades and/or one or more of the configuration setting changes to the security system, as indicated at block 44. The security system may include a plurality of security cameras each providing a respective camera feed, and one or more of the upgrades may include adding one or more video analytics algorithms to process one or more camera feeds of the plurality of security cameras and/or adding one or more security cameras to the security system. Adding one or more video analytics algorithms may include adding a video analytics algorithm that provides video summarization and reporting of one or more camera feeds of the plurality of security cameras to an operator console of the security system. In some cases, the method 20 may further include logging for each alarm in the alarm log an indication of how the respective alarm was resolved by a security operator, as indicated at block 46. In some cases, determining one or more of the configuration setting changes may include tightening one or more security settings and/or relaxing one or more security settings based at least in part on the indication of how one or more of the alarms were resolved, as indicated at block 48.

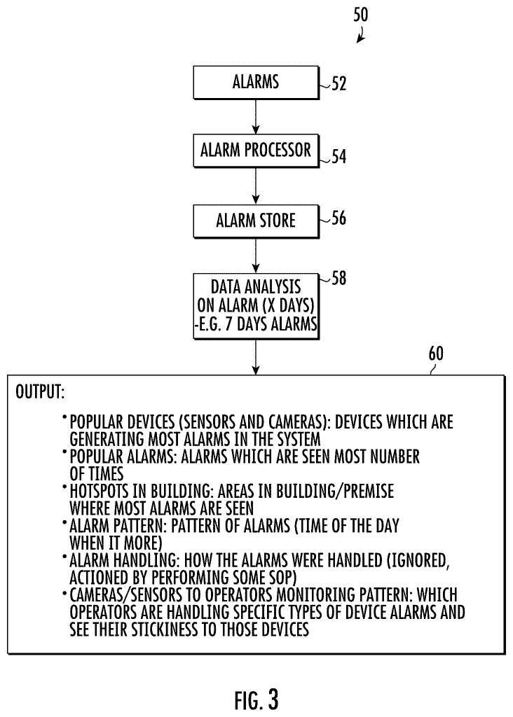

FIG. 3 is a flow diagram showing an illustrative workflow or method 50. Alarms are received, as indicated at block 52. The alarms are processed, as indicated at block 54, and are stored, as indicated at block 56. Data analysis is performed on the stored alarms, as indicated at block 58. In some cases, data analysis may be performed on the previous seven (7) days of alarms data, but other time periods are contemplated. The data analysis may result in a variety of different outputs, as indicated at block 60. This may include identifying which devices are generating the most alarms. This may include identifying which alarms are most common. The output may include identifying particular hotspots within the facility. Alarm patterns and how alarms were handled may be part of the output. In some cases, the output may include details regarding which operators are handling which alarms.

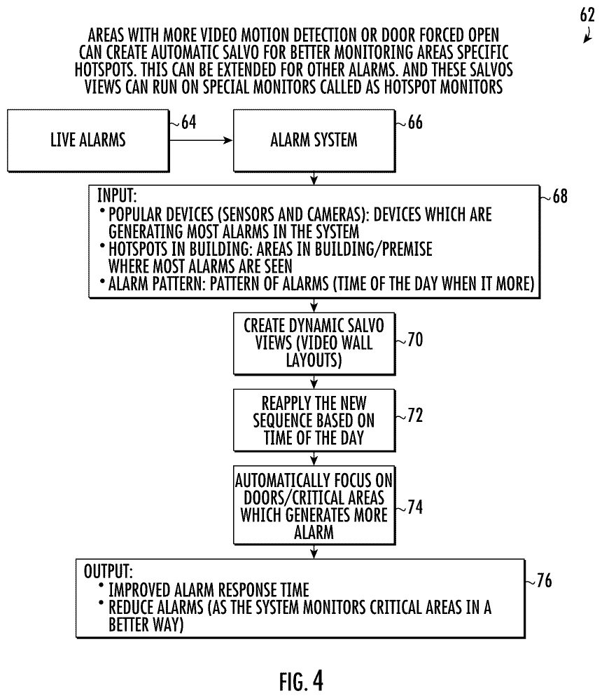

FIG. 4 is a flow diagram showing an illustrative workflow or method 62. In this example, alarms can create automatic salvos for better monitoring. Live alarms, as indicated at block 64, are provided to an alarm system, as indicated at block 66. Inputs may include popular devices, hotspots in the building and alarm patterns, as indicated at block 68 (see also FIG. 3). Dynamic salvo views (view wall layouts) are created, as indicated at block 70. A new sequence of salvos and/or new wall layouts may be reapplied, based on time of day, as indicated at block 72, to direct the security operator's attention to anticipated hot spots. The system may automatically focus on doors or other critical areas that have previously generated the most alarms, as indicated at block 74. Outputs may include improved alarm response times and a reduction in total alarms, as indicated at block 76.

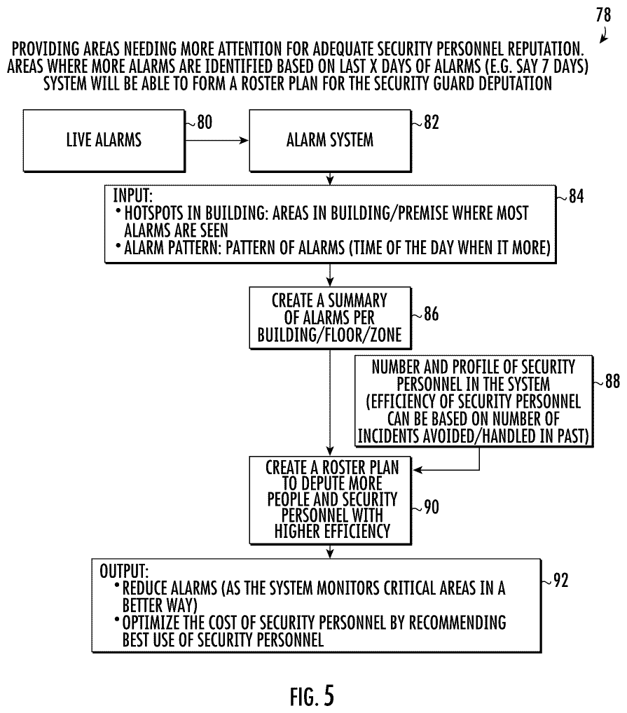

FIG. 5 is a flow diagram showing an illustrative workflow or method 78. In this example, some areas needing additional attention are identified. Live alarms, as indicated at block 80, are provided to an alarm system, as indicated at block 82. Inputs may include hotspots and alarm patterns, as indicated at block 84 (see also FIG. 3). A summary of alarms is created, as indicated at block 86. Information regarding security personnel is assembled, as indicated at block 88. Based on the summary of alarms and the information regarding security personnel, a roster plan is created, as indicated at block 90. The roster plan may specify the number and/or type of security personnel that should be rostered and deployed to handle the anticipated number of alarms/events. Outputs may include a reduction in alarms and optimized security personnel usage, as indicated at block 92.

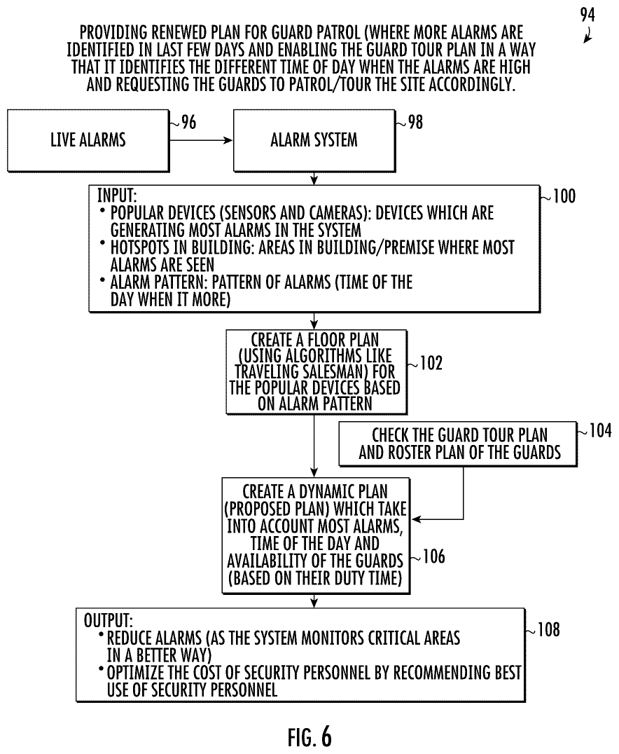

FIG. 6 is a flow diagram showing an illustrative workflow or method 94. In this example, a renewed plan for guard patrol is provided. Live alarms, as indicated at block 96, are provided to an alarm system, as indicated at block 98. Inputs may include popular devices, hotspots and alarm patterns, as indicated at block 100 (see also FIG. 3). A floor plan identifying travel routes for the guards is created based on the popular devices and the alarm patterns, as indicated at block 102. Guard tour information is checked, as indicated at block 104. Based on the floor plan and guard tour information, a dynamic floorplan is created, as indicated at block 106, which takes into account most alarms, time of day and availability of the guards (duty times). Outputs may include a reduction in alarms and optimized security personnel usage, as indicated at block 108.

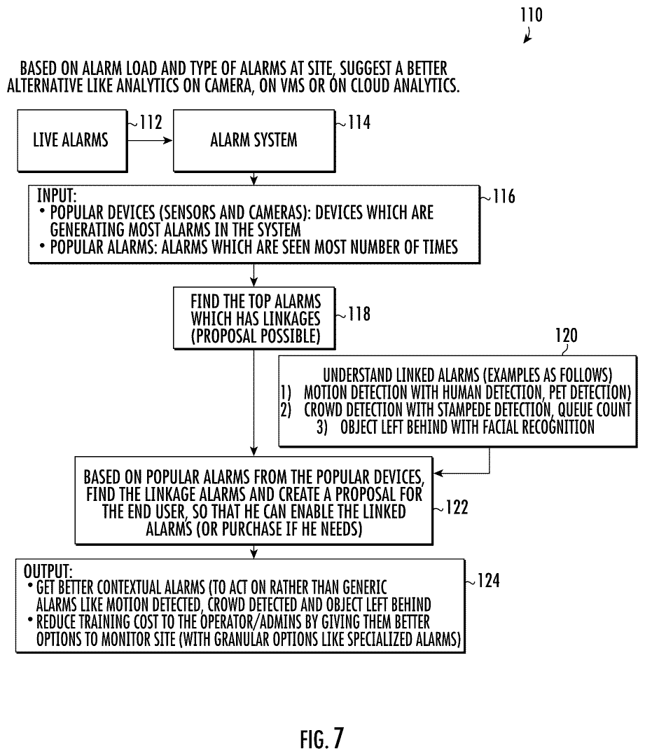

FIG. 7 is a flow diagram showing an illustrative workflow or method 110. In this example, better system equipment may be provided. Live alarms, as indicated at block 112, are provided to an alarm system, as indicated at block 114. Inputs may include popular devices and popular alarms, as indicated at block 116 (see also FIG. 3). Top alarms are found, as indicated at block 118. Linked alarms are understood, as indicated at block 120. Understanding linked alarms include, for example, (1) motion detection with human detection, pet detection; (2) crowd detection with stampede detection, queue count; or (3) object left behind detection with facial recognition. Linkage alarms are then identified, as indicated at block 122. Outputs may include better contextual alarms, and reduced training costs, as indicated at block 124.

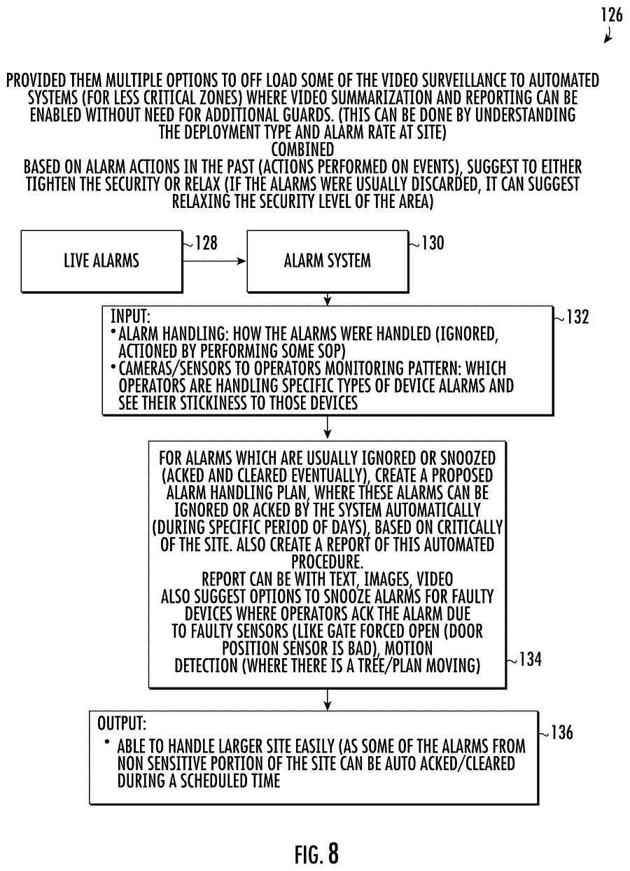

FIG. 8 is a flow diagram showing an illustrative workflow or method 126. In this example, video surveillance may be offloaded to automated systems and security levels may be optimized. Live alarms, as indicated at block 128, are provided to an alarm system, as indicated at block 130. Inputs may include alarm handling and cameras/sensors to operator's monitoring patterns, as indicated at block 132. A proposed alarm handling plan for alarms that are usually ignored or snoozed, and suggestions for snoozing alarms may be provided, as indicated at block 134. Outputs include an ability to handle a larger site, as indicated at block 136.

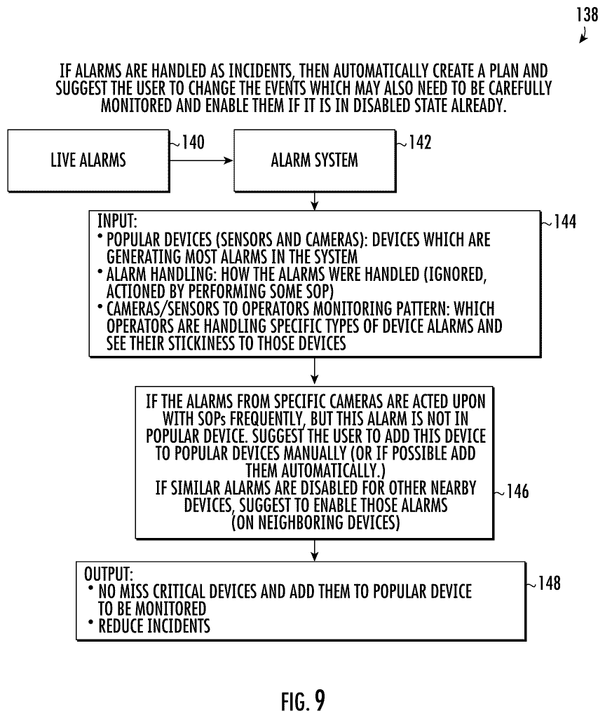

FIG. 9 is a flow diagram showing an illustrative workflow or method 138. In this example, alarms may be handled as incidents and a plan may be automatically created. Live alarms, as indicated at block 140, are provided to an alarm system, as indicated at block 142. Inputs may include popular devices, alarm handling and cameras/sensors to operator's monitoring patterns. Depending on usage, some cameras may be added to popular devices, as indicated at block 144. Outputs include not missing critical devices and a reduction in incidents.

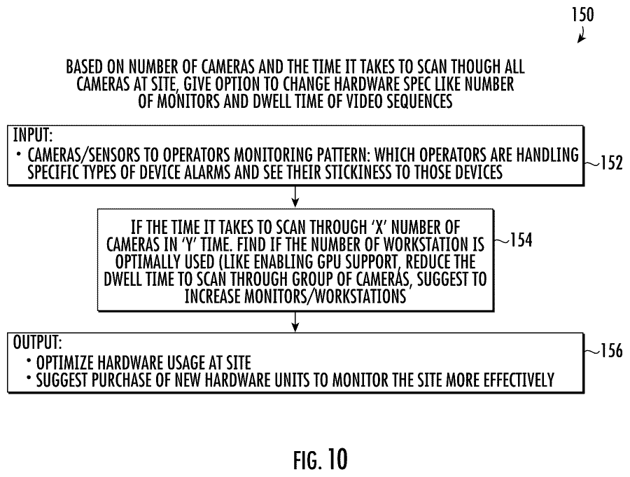

FIG. 10 is a flow diagram showing an illustrative workflow or method 150. In this example, hardware specifications may be updated. Inputs includes alarm handling and cameras/sensors to operator's monitoring patterns, as indicated at block 152. Usage is analyzed, as indicated at block 154. For example, if the time it takes to scan through “x” number of cameras in “y” time, determine whether the number of workstations is optimal (like enabling GPU support, reduce the dwell time to scan through a group of cameras, suggest to increase the number of monitors/workstations, etc.) Outputs may include optimized hardware usage and suggested purchase of new hardware, as indicated at block 156.

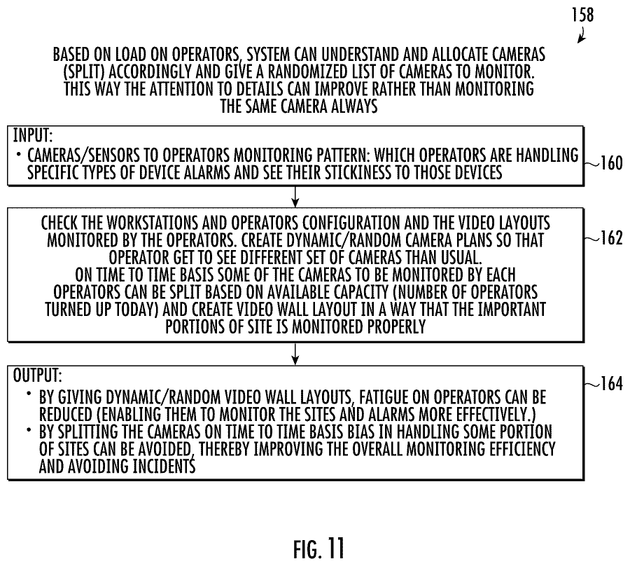

FIG. 11 is a flow diagram showing an illustrative workflow or method 158. In this example, camera monitoring assignments may be varied. Inputs include cameras/sensors to operator's monitoring patterns, as indicated at block 160. Dynamic camera plans may be generated, as indicated at block 162. For example, the system may check the workstations and operator's configuration and the video layouts monitored by the operators. Dynamic/random camera plans may be created so that operators get to see different set of cameras than usual. Alternatively, or in addition, on a time to time basis, some of the cameras that are monitored by each operator may be split among the operators based on available capacity (number of operators turned up today) and create a video wall layout in a way that the important portions of site are monitored properly. Outputs may include reduced operator fatigue by varying monitor assignments and improving overall monitoring efficiency and reduced incidents, as indicated at block 164.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for operating a security system of a facility, wherein the facility includes a plurality of secure regions, the method comprising:
receiving alarms issued by the security system of the facility, wherein each alarm includes an alarm type, an alarm time stamp, and an alarm location in the facility;
logging the received alarms in an alarm log;
identifying alarms in the alarm log that have an alarm time stamp that fall within a predetermined time window of interest;
based at least in part on the identified alarms, predicting that a first one of the plurality of secure regions of the facility will have at least a first threshold number of alarms during a first predicted future time period; and
outputting a first indication that the first one of the plurality of secure regions of the facility is predicted to have at least the first threshold number of alarms during the first predicted future time period.

2. The method of claim 1, wherein outputting the first indication comprises:
displaying a first salvo on an operator console of the security system at the first predicted future time period, wherein the first salvo includes a first camera feed that corresponds to the first one of the plurality of secure regions.

3. The method of claim 2, further comprising:
based at least in part on the identified alarms, predicting a second one of the plurality of secure regions of the facility will have at least a second threshold number of alarms during a second predicted future time period; and
outputting a second indication that the second one of the plurality of secure regions of the facility is predicted to have at least the second threshold number of alarms during the second predicted future time period, wherein outputting the second indication includes displaying a second salvo on the operator console of the security system at the second predicted future time period, wherein the second salvo includes a second camera feed that corresponds to the second one of the plurality of secure regions.

4. The method of claim 3, wherein the operator console has a plurality of displays including a dedicated hotspot display, and wherein outputting the first indication comprises displaying the first salvo on the dedicated hotspot display, and outputting the second indication comprises displaying the second salvo on the dedicated hotspot display.

5. The method of claim 1, wherein the predetermined time window of interest comprises the last seven days.

6. The method of claim 1, further comprising:
based at least in part on the identified alarms, predicting a second one of the plurality of secure regions of the facility will have at least a second threshold number of alarms during a second predicted future time period; and
outputting a second indication that the second one of the plurality of secure regions of the facility is predicted to have at least the second threshold number of alarms during the second predicted future time period.

7. The method of claim 1, further comprising:
building a security guard tour plan for one or more security guards of the facility, wherein the security guard tour plan places one or more security guards at the first one of the plurality of secure regions during the first predicted future time period.

8. The method of claim 1, further comprising:
based at least in part on the identified alarms, determining one or more upgrades and/or one or more configuration setting changes to the security system; and
making one or more of the upgrades and/or one or more of the configuration setting changes to the security system.

9. The method of claim 8, wherein the security system includes a plurality of security cameras each providing a respective camera feed, and wherein one or more of the upgrades comprises adding one or more video analytics algorithms to process one or more camera feeds of the plurality of security cameras and/or adding one or more security cameras to the security system.

10. The method of claim 9, wherein adding one or more video analytics algorithms comprises adding a video analytics algorithm that provides video summarization and reporting of one or more camera feeds of the plurality of security cameras to an operator console of the security system.

11. The method of claim 8, further comprising:
logging for each alarm in the alarm log an indication of how the respective alarm was resolved by a security operator; and
determining one or more of the configuration setting changes comprises tightening one or more security settings and/or relaxing one or more security settings based at least in part on the indication of how one or more of the alarms were resolved.

12. A security system for a facility, the security system including a plurality of secure regions, the security system comprising:
one or more alarm generating devices;
a controller operatively coupled to the one or more alarm generating devices, the controller configured to:
receive alarms issued by the alarm generating devices of the security system, wherein each alarm includes an alarm type, an alarm time stamp, and an alarm location in the facility;
log the received alarms in an alarm log;
identify alarms in the alarm log that have an alarm time stamp that fall within a predetermined time window of interest;
based at least in part on the identified alarms, predict that a first one of the plurality of secure regions of the facility will have at least a first threshold number of alarms during a first predicted future time period; and
output a first indication that the first one of the plurality of secure regions of the facility is predicted to have at least the first threshold number of alarms during the first predicted future time period.

13. The security system of claim 12, wherein the controller, when outputting the first indication, is configured to display a first salvo on an operator console of the security system at the first predicted future time period, wherein the first salvo includes a first camera feed that corresponds to the first one of the plurality of secure regions.

14. The security system of claim 13, wherein the controller is configured to:
based at least in part on the identified alarms, predict a second one of the plurality of secure regions of the facility will have at least a second threshold number of alarms during a second predicted future time period; and
output a second indication that the second one of the plurality of secure regions of the facility is predicted to have at least the second threshold number of alarms during the second predicted future time period, wherein outputting the second indication includes displaying a second salvo on the operator console of the security system at the second predicted future time period, wherein the second salvo includes a second camera feed that corresponds to the second one of the plurality of secure regions.

15. The security system of claim 14, wherein the operator console has a plurality of displays including a dedicated hotspot display, and wherein the controller is configured to display the first salvo on the dedicated hotspot display, and displays the second salvo on the dedicated hotspot display.

16. The security system of claim 12, wherein the predetermined time window of interest comprises the last seven days.

17. The security system of claim 12, wherein each alarm includes one or more of a device type of a device that generated the respective alarm, a device ID of the device that generated the respective alarm, an indication of how the respective alarm was resolved by a security operator, and an indication of which security operator resolved the respective alarm.

18. A non-transitory computer readable medium storing instructions thereon that when executed by one or more processors causes the one or more processors to:
receive alarms issued by a security system of a facility, wherein each alarm includes an alarm time stamp;
store the received alarms in an alarm log;
identify alarms in the alarm log that have an alarm time stamp that fall within a predetermined time window of interest;
based at least in part on the identified alarms, predict that a first one of a plurality of secure regions of the facility will have at least a first threshold number of alarms during a first predicted future time period; and
provide an output that directs attention of at least one security personnel to the first one of the plurality of secure regions of the facility during the first predicted future time period.

19. The non-transitory computer readable medium of claim 18, wherein the instructions cause the one or more processors to:
display a first salvo on an operator console of the security system at the first predicted future time period, wherein the first salvo includes a first camera feed that corresponds to the first one of the plurality of secure regions;
based at least in part on the identified alarms, predict a second one of the plurality of secure regions of the facility will have at least a second threshold number of alarms during a second predicted future time period; and
provide an output that directs the attention of at least one security personnel to the second one of the plurality of secure regions of the facility during the first predicted future time period, including displaying a second salvo on the operator console of the security system at the second predicted future time period, wherein the second salvo includes a second camera feed that corresponds to the second one of the plurality of secure regions.

20. The non-transitory computer readable medium of claim 19, wherein the instructions cause the one or more processors to display the first salvo on a dedicated hotspot display of the operator console, and display the second salvo on the dedicated hotspot display.
